(19) United States
(12) Patent Application Publication
(10) Pub. No.: US 2019/0390316 A1
(43) Pub. Date: Dec. 26, 2019

(54) METAL MATERIAL COOLING APPARATUS

(71) Applicant: POSCO, Pohang-si (KR)

(72) Inventor: Jung-Kuk KIM, Gwangyang-si (KR)

(21) Appl. No.: 16/465,748

(22) PCT Filed: Nov. 9, 2017
(86) PCT No.: PCT/KR2017/012652

§ 371 Date: May 31, 2019

(30) Foreign Application Priority Data
Dec. 2, 2016 (KR) 10-2016-0163778

(51) Int. Cl. C23C 2/28; C23C 2/00; C23C 2/40; C21D 1/667; B05B 13/02; B05B 12/16

(52) U.S. Cl. CPC C23C 2/28; C23C 2/003; B05B 12/16; C21D 1/667; B05B 13/0278; C23C 2/40

(57) ABSTRACT

Provided is a metal material cooling apparatus comprising: a spray cooling part for spraying a cooling medium to the surface of the metal material; and a spray angle adjusting part connected to the spray cooling part, and adjusting the spray angle of the cooling medium sprayed from the spray cooling part, according to the width of the transferred metal material, wherein the spray angle adjusting part has: a spray nozzle plate in which at least a portion of a flow path, in which the cooling medium moves, is changed such that the spray angle of the cooling medium is adjusted; and a driving member for driving the spray nozzle plate so as to change the flow path in which the cooling medium moves.

### TECHNICAL FIELD

The present invention relates to a metal material cooling apparatus which can effectively cool a metal material of various dimensions and can reduce vibration of the metal material.

### BACKGROUND ART

The following description in this section is intended to provide background information for the present disclosure and does not constitute the prior art.

FIG. 1 is a schematic diagram illustrating a plating line for a typical steel sheet, and FIG. 2 is a plan view illustrating a case in which a cooling medium is sprayed to a steel sheet by a plated steel sheet cooling apparatus according to the prior art.

Referring to FIG. 1, a steel sheet 1 (a cold rolled steel sheet), after being thermally processed through a welding machine and a looper, passes through a snout, and a sink roll 4 and a stabilizing roll 5 in a plating bath 2, in which a molten metal, for example, a molten zinc 3 is attached to the surface of the steel sheet 1, and a high-pressure air (inert gas or air) is sprayed from a gas wiping apparatus 6 (also known as ‘air knife’) in the plating bath to control a plating thickness of the steel sheet 1.

Furthermore, plating of the plated steel sheet 1 is progressively performed through a vibration control system 7, a cooling system 8, and a transfer roll 9, and here, the vibration control system suppresses the vibration of the steel sheet 1 passing through a gas wiping region, thereby achieving a uniform control on the plating thickness.

Here, the cooling system 8 is typically provided on both sides of the steel sheet 1 vertically transferred and is also referred to as cooling tower.

The cooling system 8 for the plated steel sheet is an important installation which solidifies a liquid zinc plated layer attached to the surface of the hot plated steel sheet being vertically transferred, and up to the transfer roll 9, quenches the temperature of the steel sheet 1 down to 300° C. or less, thereby facilitating the subsequent transfer of the steel sheet 1 or subsequent processes.

Here, as illustrated in FIG. 2, a conventional typical cooling system typically includes spray nozzles 13 provided in a fixed pattern in spray chambers 12 which face each other with the steel sheet 1 being vertically transferred therebetween.

However, arrangement widths of the spray nozzles 13 are fixed to be at least wider than a maximum width L1 of the steel sheet 1 to be plated and produced. Accordingly, in the case in which the width L1 of the steel sheet 1 being plated is smaller than a spray width L2 of a cooling medium sprayed through the spray nozzles, in region A where the steel sheet 1 is absent, flows of the cooling medium sprayed with high pressures crash one other, thus amplifying vortices.

Consequently, such amplification of vortices would lead to amplification of edge vibrations at both edges of the vertically transferred steel sheet 1.

In particular, in a case in which the steel sheet 1 is a moderate- to wide-width material having a relatively large width, a range of crashing pressures of vertically sprayed air is relatively large, and thus, compared to a narrow-width material, the vibrations at both edges of such a steel sheet 1 may be significantly increased by strong vortex flows generated due to crashing of sprayed air in upper and lower portions.

Such increased vibrations of the steel sheet 1 may cause various issues along the plating line. For example, such increased vibrations may require tensions applied to the stabilizing roll 5 or the transfer roll 9 to increase in order to reduce the vibration, thus increasing wear and tear of the rolls, may cause cooling performance to degrade, and may render it difficult to increase the plating speed of the steel sheet 1 due to the vibrations, causing a decrease in productivity.

Furthermore, as illustrated, when producing a plated steel sheet with a relatively narrow width, the cooling medium is excessively sprayed even into regions outside the cooling region in a width direction of the steel sheet 1, thus causing an overload on an air blower and a decrease in cooling efficiency. These issues may result in a decrease in productivity.

Therefore, it is necessary to develop a steel sheet cooling apparatus capable of reducing the vibration of steel sheet, enhancing the cooling performance, and increasing the line speed, to improve productivity.

The prior art of the present disclosure includes Utility Model Gazette No. 1989-0002975 (Apparatus for cooling non-water cooled leading end portion of hot rolled steel sheet, the date of application: 24 Dec. 1998, the name of the applicant: Pohang Iron and Steel Company).

### DISCLOSURE

### Technical Problem

According to an aspect of the present disclosure, there may be provided a metal material cooling apparatus which can enhance cooling performance for a metal material and reduce undulations of the metal material, by changing a spray angle of a cooling medium and thereby adjusting a spray width of the cooling medium.

There may be provided a metal material cooling apparatus which can improve productivity by reducing vibrations of metal material, improving cooling performance, and increasing line speed.

### Technical Solution

According to an aspect of the present disclosure, there is provided a metal material cooling apparatus, including: a spray cooling part configured to spray a cooling medium onto a surface of the metal material; and a spray angle adjusting part connected to the spray cooling part and configured to adjust a spray angle of the cooling medium sprayed from the spray cooling part according to a width of the metal material, wherein the spray angle adjusting part includes: a spray nozzle plate in which at least a portion of a flow path in which the cooling medium moves is able to change; and a driving member configured to drive the spray nozzle plate to change the flow path in which the cooling medium moves.

Preferably, the spray nozzle plate may include: a central nozzle plate installed in a central region in front of the spray cooling part and configured to spray the cooling medium in a forward direction; and stacked nozzle plates disposed at both sides of the central nozzle plate and including a plurality of stacked plate members stacked one on top of another in multiple levels, the plurality of stacked plate members being configured to be driven by the driving member so as to adjust a spray angle of the cooling medium in a width direction toward the metal material being transferred.

Preferably, in the stacked nozzle plate, the plurality of stacked plate members having spray holes in identical positions are stacked one on top of another in multiple levels, wherein the spray holes of the plurality of stacked plate members stacked one on top of another are in communication with one another, thereby forming a plurality of flow paths for the cooling medium, and as adjacent stacked plate members slide by each other, positions of the spray holes are adjusted, thereby changing the flow paths for the cooling medium.

Preferably, in the stacked nozzle plates, a spray angle of the plurality of flow paths may increase in an outward direction as a distance from the central nozzle plate increases.

Preferably, each of the stacked plate members may include: a stacked plate main body including a plurality of spray holes forming a flow path for the cooling medium, wherein the plurality of spray holes are spaced apart from one other; and a slide member including at least one of a stop member and a slide hole, wherein the stop member protrudes from one side of the stacked plate main body, and the slide hole is configured to permit the stop member to be inserted therein and to allow the stop member to slide while being inserted therein.

Preferably, a length of the slide hole of each of the stacked plate members may relatively increase in a direction from the spray cooling part to the metal material.

Preferably, the stacked nozzle plate may include: a first stacked plate member fixed to the spray cooling part or the central nozzle plate; a plurality of second stacked plate members, stacked on the first stacked plate member and connected to one another, and configured to slide and thereby change the flow paths in which the cooling medium moves; and a third stacked plate member stacked on the second plate members and installed in connection with the driving member.

Preferably, each of the second stacked plate members may include: a stacked plate main body including a plurality of spray holes forming flow paths for the cooling medium, wherein the plurality of spray holes are spaced apart from each other; a stop member protruding from one side of the stacked plate main body stacked; and a slide hole configured to permit the stop member to be inserted therein and to allow the stop member to slide while being inserted therein, wherein the first stacked plate member and the third stacked plate member each include at least one of the stop member and the slide hole, formed in the stacked plate main body.

Preferably, the spray cooling part may include: a main chamber connected to a fluid supply line configured to receive the cooling medium; a spray chamber provided on a front surface of the main chamber and installed in multiple levels in a transfer direction of the metal material; and a nozzle plate member formed on a front surface of the spray chamber and including a spray line formed in connection with the spray nozzle plate and configured to spray the cooling medium.

Preferably, the spray cooling part may further include a guide rail configured to slidably support the plurality of stacked plate members installed on the front surface of the spray chamber.

Preferably, in a case in which the spray chamber includes a plurality of spray chambers installed in the spray cooling part in multiple levels in the transfer direction of the metal material, the spray nozzle plate includes a plurality of spray nozzle plates installed to correspond to the plurality of spray chambers.

Preferably, the spray angle adjusting part may include: a narrow-width material spray mode in which positions of the spray holes of the plurality of stacked plate members stacked in multiple levels coincide with one another for spraying the cooling medium to a front surface of the metal material; and a wide-width material spray mode in which the spray holes of the plurality of stacked plate members stacked in multiple levels are spread outwardly within a range that allows the spray holes to remain in communication with one another for spraying the cooling medium at a predetermined angle.

Preferably, the driving member may include: a rotary drive motor installed in the spray cooling part; a central gearbox connected to a motor shaft of the rotary drive motor; a pair of gear bars connected to the central gearbox in lateral directions; and a pair of nozzle plate frames installed on the gear bars, configured to slide on the gear bars by rotation of the gear bars, and connected to the first stacked plate member.

Preferably, the driving member may further include: a pair of upper lateral gearboxes connected to lateral end portions of the gear bars; a pair of power transmission bars having upper ends connected to the upper lateral gearboxes and installed in a height direction; a pair of lower lateral gearboxes connected to lower ends of the power transmission bars; and a pair of auxiliary gear bars connected to the lower lateral gearboxes and to which a lower portion of the nozzle plate frame is slidably connected.

Preferably, the metal material cooling apparatus may further include: a cooling moving part configured to move the spray cooling part so as to adjust a distance between the metal material and the spray cooling part.

### Advantageous Effects

According to the embodiments of the present disclosure described above, the metal material cooling apparatus may improve the cooling performance for the metal material and reduce vibrations of the metal material, by changing the spray angle of the cooling medium and thereby adjusting a spray width of the cooling medium,.

According to an embodiment of the present disclosure, productivity may be improved by reducing the vibrations of the metal material and enhancing the cooling performance.

### BRIEF DESCRIPTION OF THE DRAWINGS

FIG. 1 is a diagram illustrating a conventional plating line for a metal material.

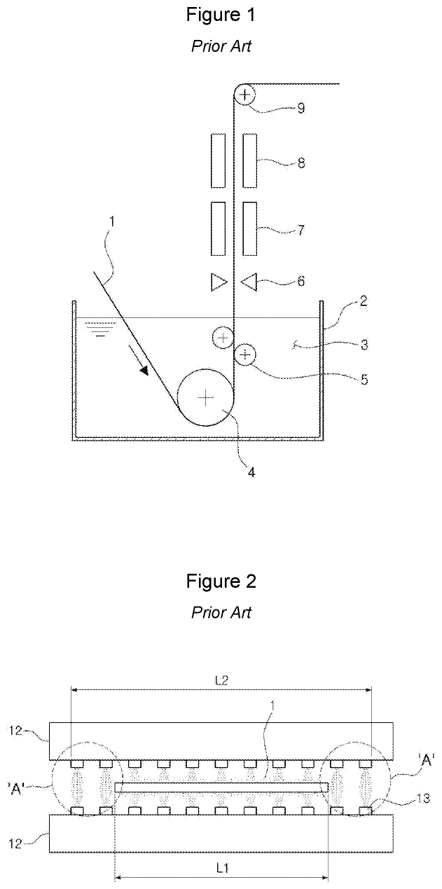

FIG. 2 is a plan view illustrating a case in which a cooling medium is sprayed using a conventional metal material cooling apparatus.

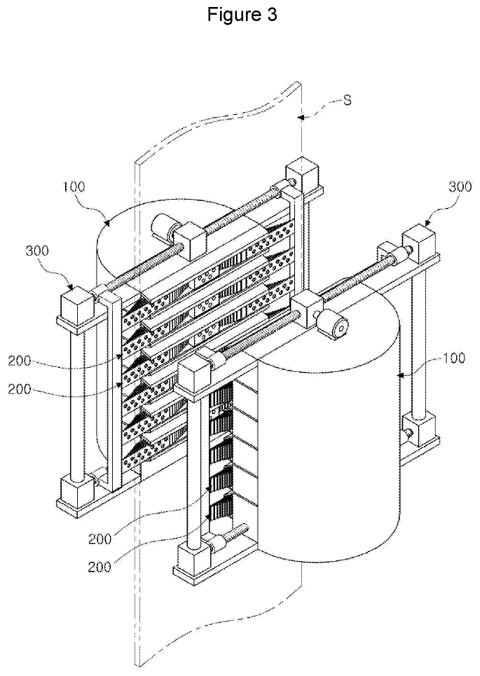

FIG. 3 is a diagram illustrating a metal material cooling apparatus according to an embodiment of the present disclosure.

FIG. 4 is a diagram illustrating a metal material cooling apparatus disposed on one side of FIG. 3.

FIG. 5 and FIG. 6 are diagrams illustrating a state before a spray nozzle plate is driven by a driving member.

FIG. 7 and FIG. 8 are diagrams illustrating a state after a spray nozzle plate is driven by a driving member.

FIG. 9a is a diagram illustrating a state before stacked nozzle plates, in which a plurality of stacked plate members are stacked one on top of another, are slid.

FIG. 9b is a diagram illustrating a state after stacked nozzle plates, in which a plurality of stacked plate members are stacked one on top of another, are slid.

FIG. 9c is an exploded perspective view of a stacked nozzle plate.

FIG. 10 is a diagram illustrating a stacked nozzle plate when a flow path is changed.

FIG. 11 is diagrams illustrating a narrow-width material spray mode and a wide-width material spray mode of a metal material cooling apparatus of the present disclosure.

### MODES OF THE INVENTION

Hereinafter, example embodiments of the present disclosure will be described with reference to the accompanying drawings. However, it should be understood and obvious to one skilled in the art that the embodiments of the present disclosure thus described may be further modified without departing from the spirit and scope of the present disclosure, and the embodiments described herein should not be construed to limit the scope of the present disclosure. Furthermore, the embodiments of the present disclosure are provided to give one skilled in the art a better understanding of the present disclosure. In the accompanying drawings, shapes, sizes, and the like, of components may be exaggerated or simplified for clarity.

Hereinbelow, a metal material cooling apparatus according to an example embodiment of the present disclosure will be described in greater detail with reference to the drawings.

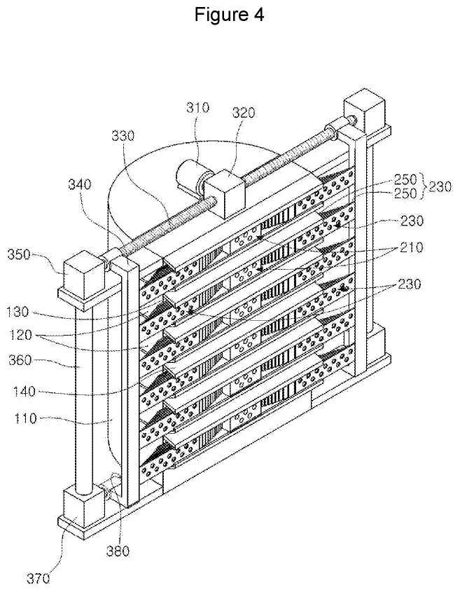

Referring to FIG. 3 to FIG. 11, the metal material cooling apparatus according to an example embodiment includes a spray cooling part 100 and a spray width adjusting part, and may further include a cooling moving unit (not illustrated).

The metal material cooling apparatus includes a spray cooling part 100 configured to spray a cooling medium to a surface of a metal material S, and a spray angle adjusting part connected to the spray cooling part 100 and configured to adjust a spray angle of the cooling medium being sprayed from the spray cooling part 100. In particular, the spray angle adjusting part may include a spray nozzle plate 200 in which at least a portion of a flow path L, in which the cooling medium moves, is able to change, and a driving member 300 configured to drive the spray nozzle plate 200 to change the flow path L in which the cooling medium moves.

As illustrated in FIG. 3, a pair of the metal material cooling apparatuses according to the present disclosure may be placed to face each other with a metal material S disposed therebetween.

A pair of the spray cooling parts 100 may be disposed to face each other with the metal material S disposed therebetween to be able to spray the cooling medium to both surfaces of the metal material S being transferred.

Each of the spray cooling part 100 may include a main chamber 110 and a spray chamber 120, and a spray angle adjusting part may be installed in connection with the spray chamber 120.

Metals of various kinds may be applied to the metal material S, which serves as a cooling target for the metal material cooling apparatus to cool.

For example, the metal material S serving as a cooling target for the metal material cooling apparatus of the present disclosure may be formed of a steel material, such as steel or stainless steel.

The metal material S serving as a cooling target of the present disclosure may be formed as a strip, which is a thin plate material.

Here, the metal material S may be a strip that passes through a plating bath to be plated with a molten metal, such as molten zinc, on a surface thereof, and is vertically transferred.

Also, the metal material S serving as a cooling target of the present disclosure may be a strip which is transferred after passing through at least one of a roughing mill and a finishing mill.

According to a width of the strip, the spray angle of the cooling medium may be adjusted by the spray angle adjusting part.

The metal material S serving as a cooling target of the present disclosure is not limited to a strip, but may be a semi-finished product of various shapes such as a slab, a bloom, a billet, and the like, that are formed by continuously injecting molten steel into a mold having a fixed shape, and then continuously drawing a slab semi-solidified inside the mold downwardly from the mold.

Wide-width materials having relatively wide widths, such as slabs, and materials having relatively small widths, such as billets, may be cooled by the metal material S cooling apparatus of the present disclosure.

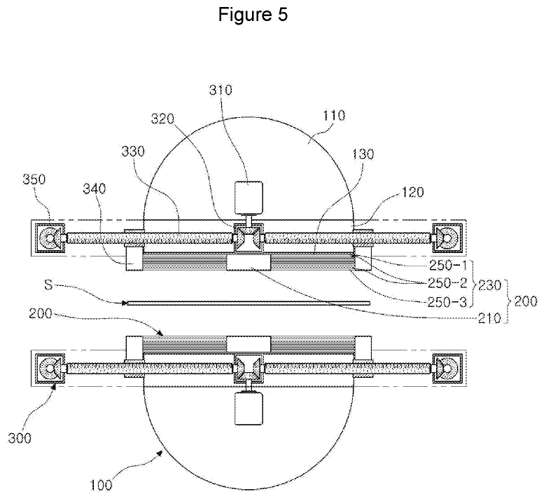

As illustrated in FIG. 3 and FIG. 4, the spray cooling part 100 may include a main chamber 110, spray chambers 120, and a nozzle plate member 130.

The spray cooling part 100 may include the main chamber 110 connected to a fluid supply line receiving the cooling medium, the spray chambers 120 provided in front of the main chamber 110 and installed in multiple layers in a transfer direction of the metal material S, and the nozzle plate member 130 formed in front of the spray chambers 120 and in which a spray line 131 spraying the cooling medium is formed in connection with the spray nozzle plate 200.

Here, the main chamber 110 may be connected to a fluid supply line (not illustrated), and the spray chambers 120 may include a plurality of spray chambers 120 installed in the main chamber 110 in multiple levels in a transfer direction of the metal material S.

The nozzle plate member 130 may include a nozzle frame fixed to the spray chambers 120, and a spray line 131 formed penetrating the nozzle frame and disposed in communication with a rear surface of a region having a plurality of spray holes H disposed in a stacked plate member 250.

The spray line 131 may be provided in the form of a single through-duct formed across a region including the entire region in which the plurality of spray holes H are formed.

Here, the cooling medium sprayed from the spray cooling part 100 may be of any type of fluids including gas and liquid, such as water, air, and the like.

As illustrated in FIG. 4, the spray cooling part 100 may further include a guide rail 140 configured to slidably support a plurality of stacked plate members 250 installed in front of the spray chambers 120.

The guide rail may be fixed to the spray chambers 120 or a nozzle plate member 130 installed at the spray chambers 120, and a pair of rail members having an L-shaped cross-section may be disposed in a vertical direction.

As illustrated in FIG. 3 and FIG. 4, in a case in which the spray chambers 120 include a plurality of spray chambers 120 installed in the spray cooling part 100 in multiple levels in a transfer direction of the metal material S, the spray nozzle plate 200 may include a plurality of spray nozzle plates 200 installed so as to correspond to the plurality of spray chambers 120.

The spray width adjusting part is a part connected to the spray cooling part 100 and configured to adjust a spray angle of a cooling medium being sprayed from the spray cooling part 100 according to a width of the transferred metal material S serving as the cooling target.

As illustrated in FIG. 3, the spray width adjusting part may include a spray nozzle plate 200 and a driving member 300.

In the spray nozzle plate 200, at least a portion of a flow path L, in which the cooling medium moves, may change so as to adjust the spray angle.

The driving member 300 may drive the spray nozzle plate 200 to change the flow path L in which the cooling medium moves, and accordingly, the spray angle of the cooling medium being sprayed from the spray cooling part 100 may be adjusted according to the width of the metal material S.

According to the present disclosure, the driving member 300 is installed outside the spray cooling part 100 so as to not interfere with the flow path for the cooling medium inside the spray cooling part 100. Therefore, flows of the cooling medium inside a spraying means can be prevented from crashing each other, thus minimizing flow resistance of fluid and preventing a decrease in spray pressure of the cooling medium, and thus, the cooling efficiency for the metal material S can be improved.

As illustrated in FIG. 4, the spray nozzle plate 200 may include a center nozzle plate 210 and stacked nozzle plates 230.

The spray nozzle plate 200 may include the center nozzle plate 210 installed in a center region in front of the spray cooling part 100 and configured to spray the cooling medium in a forward direction, and the stacked nozzle plates 230 disposed on both side surfaces of the center nozzle plate 210 and including a plurality of stacked plate members 250 stacked in multiple levels and configured to be driven by the driving member 300 so as to adjust a spray angle of the cooling medium in a width direction toward the metal material S being transferred.

As illustrated in FIG. 6 and FIG. 8, in the center nozzle plate 210, a plurality of spray holes H may be spaced apart from one another, and the spray holes H located in a center of the center nozzle plate 210 may spray the cooling medium in a forward direction, while the spray holes H located on the sides away from the center may spray the cooling medium while forming a fixed outward angle with respect to the forward direction.

The stacked nozzle plates 230 may include a plurality of stacked plate members 250 stacked one on top of another in multiple levels, and as the stacked plate members 250 are moved in connection with a driving means, a spray angle of the cooling medium in a width direction toward the metal material S may be adjusted.

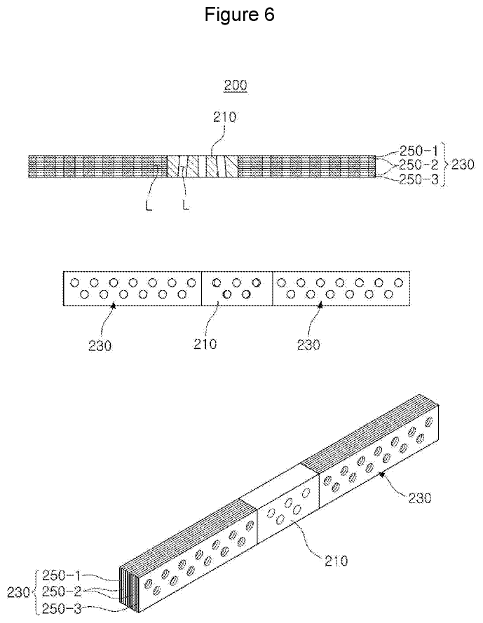

As illustrated in FIG. 5 and FIG. 6, the stacked nozzle plates 230 may be disposed as a pair while having the center nozzle plate 210 disposed therebetween.

Before the stacked nozzle plates 230 are moved by the driving means 300, the flow path L for the cooling medium may be formed in a forward direction.

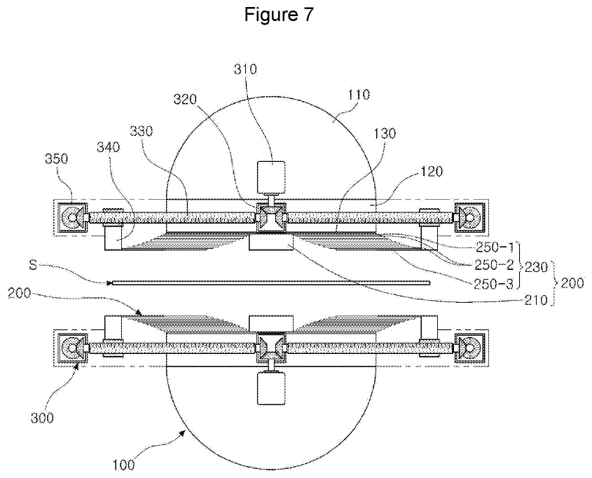

As illustrated in FIG. 7 and FIG. 8, in a case in which the plurality of stacked plate members 250 are driven by the driving means to slide outwardly from the center nozzle plate 210, the flow path L in which the cooling medium moves in the stacked nozzle plates 230 changes in an outward direction, thereby increasing the spray angle of the cooling medium in a width direction.

In the stacked nozzle plate 230, a plurality of stacked plate members 250 having spray holes H formed in identical positions are stacked one on top of another in multiple levels, and as the spray holes H of the plurality of stacked plate members 250 stacked one on top of another may communicate with one other, thereby forming a plurality of flow paths L for the cooling medium. As adjacent stacked plate members 250 slide against each other and positions of the spray holes H are adjusted, the flow paths L for the cooling medium may change.

The stacked nozzle plate 230 may include a plurality of stacked plate members 250 having identical dimensions stacked one on top of another, and the stacked plate members 250 may have the spray holes H formed in identical positions.

As illustrated in FIG. 5 and FIG. 6, in a case in which a plurality of stacked plate members 250 are stacked in a forward arrangement, the spray holes H of the plurality of stacked plate members 250 may form the flow paths L in a forward direction.

As illustrated in FIG. 7 and FIG. 8, in a case in which the plurality of stacked plate members 250 slide outwardly from the central nozzle plate 210, the spray holes H of the plurality of stacked plate members 250 may form the flow paths L having a spray angle in a fixed direction with respect to the forward direction.

The stacked nozzle plate 230, although not illustrated, may be configured such that the plurality of flow paths L form a spray angle that increases in an outward direction as a distance from the center nozzle plate 210 decrease.

That is, the flow path L, which is formed by a plurality of spray holes H disposed adjacent to the center nozzle plate 210 communicating with one another, has a spray angle greater in an outward direction, as compared to the flow path L formed by a plurality of spray holes H disposed relatively further away from the center nozzle plate 210 communicating with one another.

For example, when three flow paths L are formed in the stacked nozzle plate 230, wherein a first flow path L closest to the center nozzle plate 210 has a spray angle 81, a second flow path L has a spray angle of 82, and a third flow path L disposed the farthest from the center nozzle plate 210 has a spray angle of 83, the flow paths L may be formed such that, as a flow path L is located further away from the center nozzle plate 210, the spray angle of said flow path L increases in an outward direction (θ1<θ2<θ3).

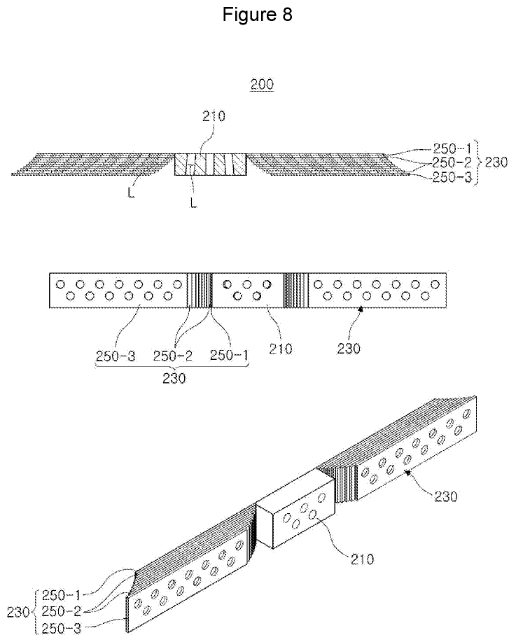

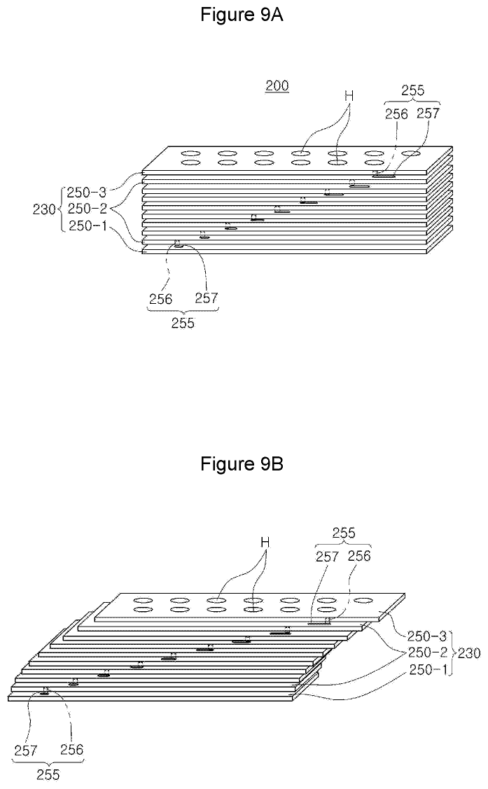

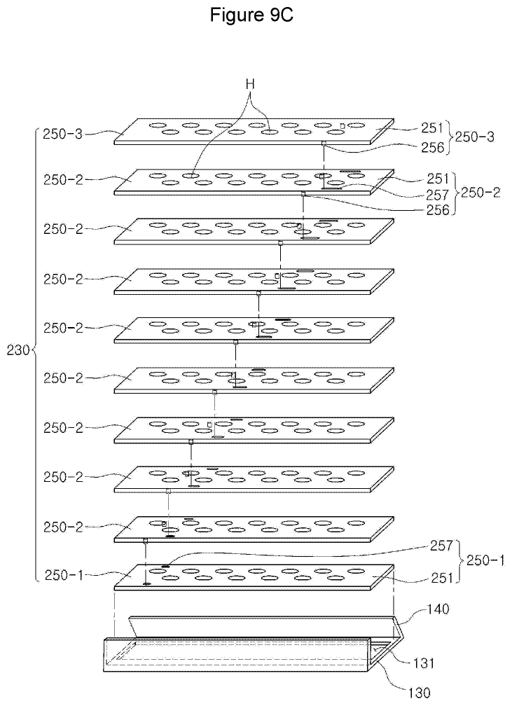

As illustrated in FIGS. 9a to 9c, the stacked plate member 250 may include a stacked plate main body 251 and a slide member 255.

The stacked plate member 250 may include a stacked plate main body 251 in which a plurality of spray holes H forming a flow path L for the cooling medium are spaced apart from one another, and at least one of a stop member 256 and a slide hole 257, wherein the stop member 256 protrudes from one side of the stacked plate main body 251, and the slide hole 257 is configured to fix the stop member 256 such that the stop member 256 is able to slide while being inserted in the slide hole 257.

In other words, the stacked plate member 250 may include the stacked plate main body 251, the stop member 256, and the slide hole 257, or may include the stacked plate main body 251 and the stop member 256, or may include the stacked plate main body 251 and the slide hole 257.

As illustrated in FIG. 9a to FIG. 9c, lengths of the slide holes 257 of the stacked plate members 250 may progressively increase in a direction from the spray cooling part 100 to the metal material S.

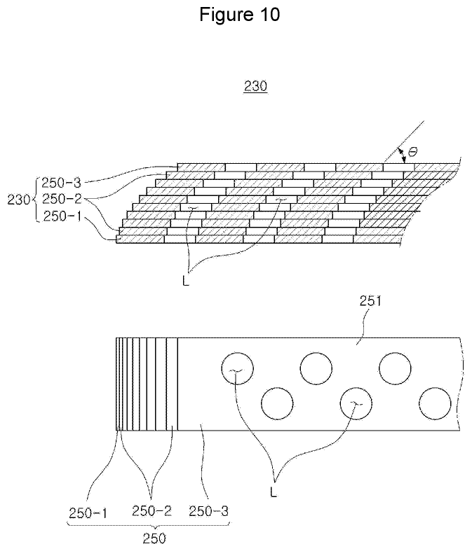

As illustrated in FIG. 10, while the plurality of stacked plate members 250 are in a slid state, stacked plate members 250 disposed relatively closer to the center nozzle plate 210 may slide by a relatively smaller distance, and stacked plate members 250 disposed relatively farther away from the center nozzle plate 210 may move by a relatively greater distance.

Accordingly, the flow paths L formed in the stacked nozzle plate 230 may form a flow path L bent outwardly from the center nozzle plate 210, and the stacked nozzle plate 230 may spray the cooling medium while facing outwardly from the center nozzle plate 210.

As described above, the cooling medium is sprayed from the stacked nozzle plate 230 in an outward direction away from the center nozzle plate 210, and thus, as the cooling medium sprayed from the center nozzle plate 210 and the stacked nozzle plate 230 is being guided to be discharged toward end portions of the metal material S in a width direction, the generation of vortices due to stasis of the cooling medium may be reduced, and the cooling efficiency may be improved.

As illustrated in FIG. 9a to FIG. 9c, the stacked nozzle plates 250 may include a first stacked plate member 250-1, a plurality of second stacked plate members 250-2, and a third stacked plate member 250-3.

The stacked nozzle plate 230 may include a first stacked plate member 250-1 fixed to the spray cooling part 100 or to the center nozzle plate 210, a plurality of second stacked plate members 250-2 stacked on and connected to the first stacked plate member 250-1 and configured to slide and thereby change flow paths L in which the cooling medium moves, and a third stacked plate member 250-3 stacked on the second stacked plate member 250-2 and installed in connection with the driving member 300.

As illustrated in FIG. 5 and FIG. 7, a first stacked plate member 250-1, a plurality of second stacked plate members 250-2, and a third stacked plate member 250-3 may be stacked one on top of another in this order sequentially in a direction from the spray cooling part 100 toward the metal material S.

The first stacked plate member 250-1 may be fixed to the spray cooling part 100 or to the center nozzle plate 210, and a position of the first stacked plate member 250-1 may be fixed independently of driving of the driving member 300.

The second stacked plate member 250-2 may include a plurality of stacked plate members 250 slidably connected to one other between the first stacked plate member 250-1 and the third stacked plate member 250-3.

The plurality of second stacked plate members 250-2 may be connected to each other while being stacked one on top of another in multiple levels between the first stacked plate member 250-1 and the third stacked plate member 250-3, and may slide and thereby change the flow paths L in which the cooling medium moves.

The third stacked plate member 250-3 may be fixed so as to be able to be driven in connection with the driving member 300.

The third stacked plate member 250-3 may be fixed to the nozzle plate frame 340, and the nozzle plate frame 340 may be driven in connection with the driving member 300, thereby causing the third stacked plate member 250-3 to move.

When the driving member 300 is driving, the third stacked plate member 250-3 slides and thereby causes the plurality of second stacked plate members 250-2 installed in connection with the third stacked plate member 250-3 to slide, thereby causing the second stacked plate members 250-2 in multiple levels to spread outwardly.

As illustrated in FIG. 9a to FIG. 9c, a second stacked plate member 250-2 may include a stacked plate main body 251, a stop member 256, and a slide hole 257.

The second stacked plate member 250-2 may include a stacked plate main body 251 in which a plurality of spray holes H forming a flow path L for a cooling medium are spaced apart from each other, a stop member 256 protruding from one side of the stacked plate main body 251 being stacked, and a slide hole 257 configured to fix the stop member 256 such that the stop member 256 is able to slide while being inserted in the slide hole 257, and the first stacked plate member 250-1 and the third stacked plate member 250-3 may each include at least one of the stop member 256 formed in the stacked plate main body 251 and the slide hole 257.

The slide hole 257 is provided in the shape of an elongated hole and permits the stop member 256 to slide in a fixed region.

In the stacked nozzle plate 230, the first stacked plate member 250-1, the plurality of second stacked plate members 250-2, and the third stacked plate member 250-3 are sequentially stacked one on top of another in a direction from the spray cooling part 100 to the metal material, and the length of an elongated hole formed in the slide hole 257 may increase in a direction from the spray cooling part 100 to the metal material S.

The first stacked plate member 250-1 and the third stacked plate member 250-3 may each include at least one of the stop member 256 and the slide hole 257.

For example, as illustrated in FIG. 9c, the third stacked plate member 250-3 may include the stop member 256, while the first stacked plate member 250-1 includes the slide hole 257.

The stop member 256 of the third stacked plate member 250-3 may be fixed such that the stop member 256, while being inserted therein, is able to slide within the slide hole 247 of an uppermost second stacked plate member 250-2.

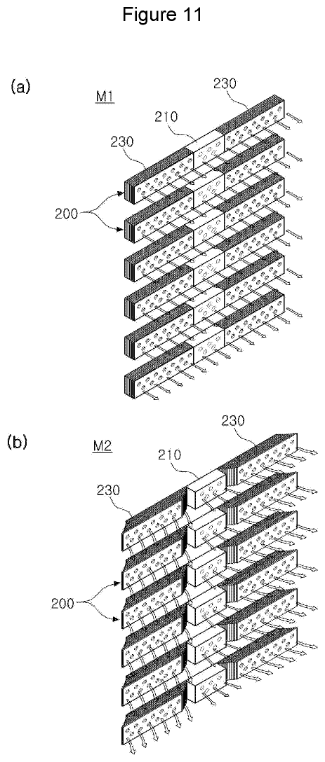

As illustrated in FIG. 11, a spray angle adjusting part may include a narrow-width material spray mode M1 and a wide-width spray mode M2.

The spray angle adjusting part may include a narrow-width material spray mode M1 in which the positions of spray holes of a plurality of stacked plate members 250 stacked one on top of another in multiple levels coincide with one other, thereby spraying a cooling medium toward a front surface of a metal material S, and a wide-width material spray mode M2 in which the positions of the spray holes H of a plurality of stacked plate members 250 stacked one on top of another in multiple levels are spread away from each other within a range permitting all of the spray holes H to remain in communication with one another, thereby spraying the cooling medium at a predetermined angle.

As illustrated in (a) of FIG. 11, the narrow-width material spray mode M1 is a cooling state applicable to a narrow-width material where a metal material S serving as a cooling target has a relatively small width; and as illustrated in (b) of FIG. 11, the wide-width material spray mode M2 is a cooling state applicable to a wide-width material where a metal material S serving as a cooling target has a relatively wide width.

As illustrated in FIG. 9a, in the narrow-width spray mode M1, a stop member 256 formed on one stacked plate member 250 is positioned in a first end portion within a slide hole 257 formed in the other stacked plate member 250, the first end portion being disposed in a direction relatively closer to the center nozzle plate 210.

As illustrated in FIG. 9b, in the wide-width material spray mode M2, a stop member 256 formed on one stacked plate member 250 may be positioned in a second end portion within a slide hole 257 formed in the other stacked plate member 250, the second end portion being disposed in a direction relatively further away from the center nozzle plate 210.

The driving member 300 may include a rotary drive motor 310, a central gearbox 320, a pair of gear bars 330, and a pair of nozzle plate frames 340.

The driving member 300 may include a rotary drive motor 310 installed in the spray cooling part 100, a central gearbox 320 connected to a motor shaft of the rotary drive motor 310, a pair of gear bars 330 connected to the central gearbox 320 in lateral directions, and a pair of nozzle plate frames 340 installed on the gear bars 330, configured to slide on the gear bars 330 by rotation of the gear bars 330, and connected to the first stacked plate member 250-1.

One end portions of the gear bars 330 may be connected to the lateral gear boxes, and the other portions of the gear bars 330 may be connected to the central gearbox 320.

The nozzle plate frames 340 may include internal threaded portions that correspond to external threaded portions of the gear bars 330.

In a case in which a plurality of spray chambers 120 are installed in the spray cooling part 100 in multiple levels in a transfer direction of the metal material S, there may be installed a plurality of spray nozzle plates 200 corresponding to the plurality of spray chambers 120.

Here, as first stacked plate members 250-1 formed in each of the spray nozzle plates 200 are connected to the nozzle plate frame 340 in a transfer direction of the metal material S, the plurality of spray nozzle plates 200 can be driven as a single body.

The driving member 300 may include a rotary drive motor 310, a central gearbox 320, gear bars 330, and a nozzle plate frame 340, and may further include a pair of upper lateral gearboxes 350, a pair of power transmission bars 360, a pair of lower lateral gearboxes 370, and a pair of auxiliary gear bars 380.

The driving member 300 may further include a pair of upper lateral gearboxes 350 connected to lateral end portions of the gear bar 330, a pair of power transmission bars 360 having upper ends connected to the upper lateral gearboxes 350 and disposed in a height direction, a pair of lower lateral gearboxes 370 connected to lower ends of the power transmission bars 360, and a pair of auxiliary gear bars 380 connected to the lower lateral gearboxes 370 and having lower portions of the nozzle plate frames 340 slidably connected thereto.

Hereinbelow, a process in which a spray nozzle plate 200 is driven by operation of the driving member 300 will be described with reference to FIG. 4 to FIG. 8.

Varvel gears are formed on a motor shaft of the rotary drive motor 310 and at one end portions of a pair of gear bars 330 and are engaged with each other inside a central gearbox 320, thereby transmitting a rotational force from the motor shaft of the rotary drive motor 310 to the gear bars 330.

Varvel gears are formed at the other end portions of the pair of gear bars 330 and at one end portions (upper ends) of the power transmission bars 360 connected to the gear bars 330 and are engaged with each other inside upper lateral gear boxes 350, thereby transmitting a rotational force to the power transmission bars 360.

Varvel gears are formed at the other end portions (lower ends) of the power transmission bars 360 and at one end portions of auxiliary gear bars 380 and are engaged with each other inside lower lateral gearboxes 370, thereby transmitting a rotational force of the power transmission bars 360 to the auxiliary gear bars 380.

Lower portions of the nozzle plate frames 340 may be slidably connected to the auxiliary gear bars 380.

Accordingly, due to a driving force provided by the rotary drive motor 310, the nozzle plate frames 340 can slide in connection with each other on the gear bars 330 and the auxiliary gear bars 380, and thus, a plurality of spray nozzle plates 200 installed in the nozzle plate frame 340 in multiple levels can move in connection with each other as a single body.

Although not illustrated, the metal material cooling apparatus may further include a cooling movable unit (not illustrated) configured to move the spray cooling part 100 so as to adjust a distance between the metal material S and the spray cooling part 100.

The cooling movable unit (not illustrated) may include a fixing frame and a forward/backward drive motor or drive cylinder positionally fixed to the fixing frame and coupled to the spray cooling part 100.

Here, the fixing frame may be a structure positionally fixed in proximity to the spray cooling part 100 and is not limited by the present disclosure.

While the present disclosure has been particularly shown and described with reference to specific embodiments, it should be understood by those skilled in the art that various changes in form and detail may be made therein without departing from the spirit and scope of the present disclosure as defined by the appended claims.

1. A metal material cooling apparatus, comprising:
a spray cooling part configured to spray a cooling medium onto a surface of the metal material; and
a spray angle adjusting part connected to the spray cooling part and configured to adjust a spray angle of the cooling medium sprayed from the spray cooling part according to a width of the metal material, wherein the spray angle adjusting part includes:
a spray nozzle plate in which at least a portion of a flow path in which the cooling medium moves is able to change; and
a driving member configured to drive the spray nozzle plate to change the flow path in which the cooling medium moves.

2. The metal material cooling apparatus of claim 1, wherein the spray nozzle plate includes:
a central nozzle plate installed in a central region in front of the spray cooling part and configured to spray the cooling medium in a forward direction; and
stacked nozzle plates disposed at both sides of the central nozzle plate and including a plurality of stacked plate members stacked one on top of another in multiple levels, the plurality of stacked plate members being configured to be driven by the driving member so as to adjust a spray angle of the cooling medium in a width direction toward the metal material being transferred.

3. The metal material cooling apparatus of claim 2, wherein in the stacked nozzle plate, the plurality of stacked plate members having spray holes in identical positions are stacked one on top of another in multiple levels, wherein the spray holes of the plurality of stacked plate members stacked one on top of another are in communication with one another, thereby forming a plurality of flow paths for the cooling medium, and as adjacent stacked plate members slide by one other, positions of the spray holes are adjusted, thereby changing the flow paths for the cooling medium.

4. The metal material cooling apparatus of claim 3, wherein in the stacked nozzle plate, a spray angle of the plurality of flow paths increases in an outward direction as a distance from the central nozzle plate increases.

5. The metal material cooling apparatus of claim 2, wherein each of the stacked plate members includes: a stacked plate main body including a plurality of spray holes forming a flow path for the cooling medium, wherein the plurality of spray holes are spaced apart from one other; and
a slide member including at least one of a stop member and a slide hole, wherein the stop member protrudes from one side of the stacked plate main body, and the slide hole is configured to permit the stop member to be inserted therein and to allow the stop member to slide while being inserted therein.

6. The metal material cooling apparatus of claim 5, wherein a length of the slide hole of each of the stacked plate members relatively increases in a direction from the spray cooling part to the metal material.

7. The metal material cooling apparatus of claim 2, wherein the stacked nozzle plate includes:
a first stacked plate member fixed to the spray cooling part or the central nozzle plate;
a plurality of second stacked plate members, stacked on the first stacked plate member and connected to one another, and configured to slide and thereby change the flow paths in which the cooling medium moves; and
a third stacked plate member stacked on the second plate members and installed in connection with the driving member.

8. The metal material cooling apparatus of claim 7, wherein each of the second stacked plate members includes:
a stacked plate main body including a plurality of spray holes forming flow paths for the cooling medium, wherein the plurality of spray holes are spaced apart from each other;
a stop member protruding from one side of the stacked plate main body stacked; and
a slide hole configured to permit the stop member to be inserted therein and to allow the stop member to slide while being inserted therein, wherein the first stacked plate member and the third stacked plate member each include at least one of the stop member and the slide hole, formed in the stacked plate main body.

9. The metal material cooling apparatus of claim 2, wherein the spray cooling part includes:
a main chamber connected to a fluid supply line configured to receive the cooling medium;
a spray chamber provided on a front surface of the main chamber and installed in multiple levels in a transfer direction of the metal material; and
a nozzle plate member formed on a front surface of the spray chamber and including a spray line formed in connection with the spray nozzle plate and configured to spray the cooling medium.

10. The metal material cooling apparatus of claim 9, wherein the spray cooling part further includes a guide rail configured to slidably support the plurality of stacked plate members installed on the front surface of the spray chamber.

11. The metal material cooling apparatus of claim 9, wherein in a case in which the spray chamber includes a plurality of spray chambers installed in the spray cooling part in multiple levels in the transfer direction of the metal material,
the spray nozzle plate includes a plurality of spray nozzle plates installed to correspond to the plurality of spray chambers.

12. The metal material cooling apparatus of claim 2, wherein the spray angle adjusting part includes:
a narrow-width material spray mode in which positions of the spray holes of the plurality of stacked plate members stacked in multiple levels coincide with one another for spraying the cooling medium to a front surface of the metal material; and
a wide-width material spray mode in which the spray holes of the plurality of stacked plate members stacked in multiple levels are spread outwardly within a range that allows the spray holes to remain in communication with one another for spraying the cooling medium at a predetermined angle.

13. The metal material cooling apparatus of claim 7, wherein the driving member includes:
a rotary drive motor installed in the spray cooling part;
a central gearbox connected to a motor shaft of the rotary drive motor;
a pair of gear bars connected to the central gearbox in lateral directions; and
a pair of nozzle plate frames installed on the gear bars, configured to slide on the gear bars by rotation of the gear bars, and connected to the first stacked plate member.

14. The metal material cooling apparatus of claim 13, wherein the driving member further includes:
a pair of upper lateral gearboxes connected to lateral end portions of the gear bars;
a pair of power transmission bars having upper ends connected to the upper lateral gearboxes and installed in a height direction;
a pair of lower lateral gearboxes connected to lower ends of the power transmission bars; and
a pair of auxiliary gear bars connected to the lower lateral gearboxes and to which a lower portion of the nozzle plate frame is slidably connected.

15. The metal material cooling apparatus of claim 1, further comprising: a cooling moving part configured to move the spray cooling part so as to adjust a distance between the metal material and the spray cooling part.
